(19) United States
(12) Patent Application Publication
(10) Pub. No.: US 2007/0225987 A1
(43) Pub. Date: Sep. 27, 2007

(54) REAL ESTATE EXCHANGE

(76) Inventor: David Bernard Gerold, Jordan, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/277,211

(22) Filed: Mar. 22, 2006

(51) Int. Cl. G06Q 10/00; G06Q 30/00

(52) U.S. Cl. 705/1

(57) ABSTRACT

A method of selling and buying a real estate lot includes registering a real estate lot, posting the registered real estate lot, reserving a registered real estate lot for purchase, and determining a fee associated to the potential sale of the registered lot. The fee is based on the number of real estate lots sold and the number of real estate lots purchased by a user in a selected time period.

### LIMITED COPYRIGHT WAIVER

A portion of the disclosure of the patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD OF THE INVENTION

The present invention relates to methods and systems for the exchange or sale or real estate, and, more particularly, to the exchange of real property between land developers and builders.

### BACKGROUND

In some instances, a party desiring a new home already has a lot on which to build. In many other instances, the home builder not only provides the new home but also provides a lot on which to build. Generally, home builders buy a number of lots in various land developments to have on hand for customers. In an ideal situation, a home builder has a lot in a development where the home buyer wants to build and the lot is perfect. Of course, many times the situation is less than ideal and the builder does not have a lot that a potential customer wants to build on. Many potential home owners are also very particular. As a result, many times the home builder loses a customer since the home builder does not have the perfect lot. In an attempt to minimize the number of customers lost, many home builders buy a number of lots in various developments to have on hand to suit most home owners. Of course, residential lots are costly. As a result, this strategy results in a high cost to the home builder. If the home builder owns the lots outright, the builder's working capital is tied up. If working capital is tied up, there may be a need for short term loans from a lender for supplies to build homes. If the home builder borrows the money needed to buy a number of lots, this can result in high payments needed to service the loans. Most of the time, lenders will not loan more than 80% of the purchase price of a lot, requiring the builder to cover 20% of the value of each lot in inventory. In each instance, there is an increasing burden on builders which squeezes their profit margins. Of course, the home builder can carry many lots in inventory and there is no guarantee that the home builder will not lose potential customers.

### BRIEF DESCRIPTION OF THE DRAWINGS

FIG. 1 is a diagrammatic representation of a system architecture, according to an example embodiment of the invention.

FIG. 2 is a diagram illustrating a more specific overall structure of a real estate lot exchange system, according to an example embodiment.

FIG. 3 is a flow diagram illustrating a method for generating a buyer fee, according to an example embodiment.

FIG. 4 is a flow diagram illustrating a method for obtaining membership information, according to an example embodiment.

FIG. 5 is a flow diagram illustrating a method for generating an intent to buy indication to a seller, according to an example embodiment.

FIG. 6 is a flow diagram illustrating a method for providing multiple interfaces, according to an example embodiment.

FIG. 7 is a flow diagram illustrating a method for limiting participation of a member, according to an example embodiment.

FIG. 8 is a flow diagram illustrating a method for limiting participation of a member, according to an example embodiment.

FIG. 9 is a flow diagram illustrating a method for penalizing a buyer and seller that circumvent the lot exchange system, according to an example embodiment.

FIG. 10 is a flow diagram of a method for buying and selling real estate, such as real estate lots, according to an example embodiment.

FIG. 11 illustrates an example computer system used in conjunction with certain example embodiments of the invention.

FIG. 12 is a schematic diagram of a machine-readable medium, according to an example embodiment.

FIG. 13 is a diagrammatic representation of a system architecture, according to another example embodiment.

FIG. 14 is a diagram illustrating a number of functions that administrative members can use and a number of functions that other members can use, according to an example embodiment.

FIG. 15 is a flow diagram illustrating a method for listing lots, according to an example embodiment.

FIG. 16 is a flow diagram illustrating a method for uploading documents related to lots, according to an example embodiment.

FIG. 17 is a flow diagram illustrating various member transactions, according to an example embodiment.

FIG. 18 is a flow diagram illustrating a method related to buyer builder purchase inquiries, according to an example embodiment.

FIG. 19 is a flow diagram illustrating a method for determining transaction fees as a result of a purchase inquiry, according to an example embodiment.

FIG. 20 is a flow diagram of a pre-closing method for buying and selling real estate, such as real estate lots, according to an example embodiment.

FIG. 21 is a flow diagram of a method for determining if a buyer and seller are attempting to circumvent the lot exchange system, according to an example embodiment.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope and spirit of the present invention. Different instances of the word “embodiment” as used within the specification do not necessarily refer to the same embodiment, but they may. The following detailed description is, therefore, not to be taken in a limiting sense, and the scope of the present invention is defined only by the appended claims.

In the following description, numerous specific details are set forth to provide a thorough understanding of the invention. It is understood, however, that the invention may be practiced without these specific details. In other instances, well-known circuits, structures, and techniques have not been shown in detail in order not to obscure the invention.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

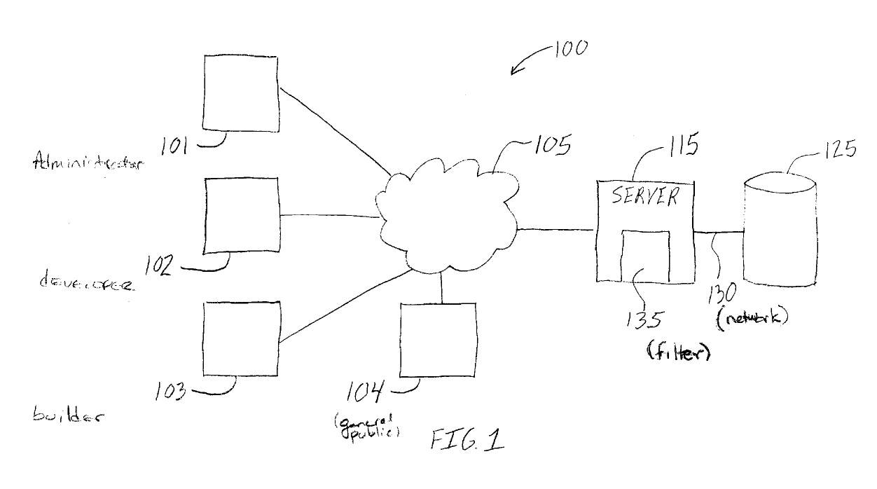

FIG. 1 is a diagrammatic representation of a system architecture 100 according to an example embodiment of the invention. In general, FIG. 1 shows an overall environment in which the present invention may be used. In some embodiments, the environment includes one or more clients 101, 102 and 103, representing a number of electronic communication devices, such as computers, personal computers or information appliances, operated by system users. In an embodiment, the clients are personal computers such as a PC or an Apple computer. Clients 101-103 are attached to a network 105. The system 100, additionally includes a server 115 connected to network 105. System 100 also includes in some embodiments a plurality of servers. System 100 further includes a database 125 connected via a network 130 to server 115. Database 125 stores data relating to real property exchange, such as property listings, prices, contact information, user ratings, transaction rates, and other data as discussed herein or known to one of skill in the art required for running a commercial database. Server 115 includes instructions capable of being executed to carry out the functions as further described herein. In an embodiment, the server 115 runs the ASP or ASP.NET programming language to provide an interface between the clients 101-103 and database 125. In an embodiment, the database 125 is an SQL database. It is within the scope of the present invention to use other database programs and server programs.

The clients 101-103 represent various levels of interaction with the server and database. Client 101 represents an administrator. An administrator using client 101 will have rights to access all data in database and revise variables as they relate to aspects of members as will be described in greater detail below. Client 102 represents a land developer. A developer using client 102 will have the ability to register real property, such as lots, for storage in the database 125 and interaction through server 115. A developer will also be able to remove a property from the exchange database. A developer will further have the ability to review his own account status as stored in the database. Client 103 represents a builder. A builder using client 103 will have the rights to review his own account status as stored in the database. A builder will further be able to search registered real property at two rights levels. At a first level, the builder will see all available information in database 125 related to a registered property. At a second, general public level, server 115 revokes some viewing rights. In an example, the server 115 includes a public viewing filter 135. Filter 135 prevents display and access to certain information, such as exchange fees or other builder business sensitive information. Client 104 represents a general public access point. The public client accesses builder member information and, in some embodiments, allows searching of registered properties albeit without prices. It will be recognized that system 100 has the ability to allow any number of clients to access database 125 through server 115 and network 105.

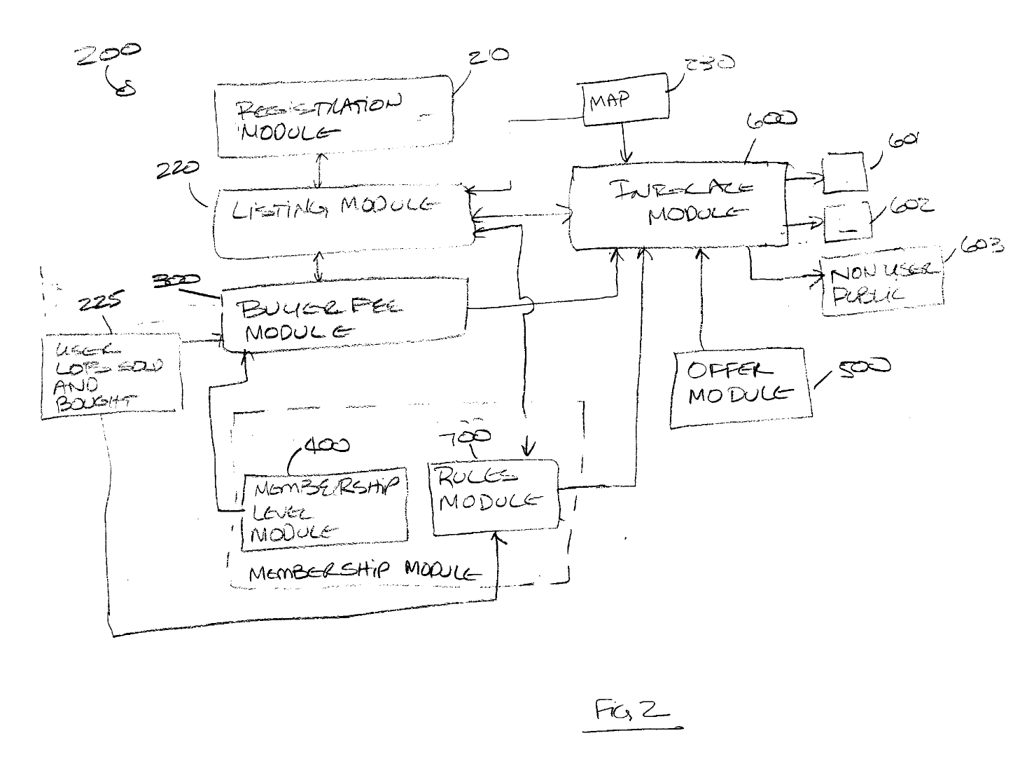

FIG. 2 is a diagram illustrating a more specific overall structure of a real estate lot exchange system 200, according to an example embodiment. The lot exchange system 200 includes a registration module 210 and a listing module 220 and a buyer's fee module 300. The lot exchange system 200 also includes a membership level module 400 which is communitively coupled to the buyer fee module 300. The lot exchange system 200 also includes an interface module 600 which produces an output or interface 601 for a first type of user, 602 for a second type of user, and 603 for a non-user or a public viewer of certain portions of the lot exchange system 200. The lot exchange system also includes an offer module 500 which actually produces an indication of an intent to buy to a seller. The lot exchange system 200 also includes a rules module 700. The rules module implements various sets of rules to either limit the participation of the users or to penalize users in certain situations. The lot exchange system 200 also includes a mapping feature, as indicated by the map 230. The lot exchange system 200 also includes or uses data 225 from the database 125 (shown in FIG. 1). The data 225 includes the number of lots bought and sold for a user, as well as other items of data.

In one embodiment, the lot exchange system 200 enables the selling and buying a real estate lots by developers, builders and other lot owners. The seller of a real estate lot can be a builder, a developer or a member of the public action through either a builder or developer. The buyer can be the same parties so that lots carried by developers or builders or others can be exchanged for other lots to satisfy customers of builders or developers and keep the business with the first party a potential new home owner first approaches. The lot exchange system provides potential home owners with a larger inventory from which to choose and allows customers to choose builders rather than the lot owner. The various modules can be implemented in hardware or software or a combination of hardware and software. Furthermore, each of the modules can be implemented as an instruction set on a microprocessor associated with a computer system or can be implemented as a set of instructions associated with any form of media, such as a set of instructions on a disk drive, a set of instructions on tape, a set of instructions transmitted over an Internet connection or the like.

The lot exchange system 200 for selling and buying a real estate lots includes a real estate lot registration module 210, and a real estate lot listing or posting module 220 communicatively coupled to the real estate lot registration module 210. In these two modules information related to the lot is gathered and posted. The offer module or intent to buy module 500 is communicatively coupled to the real estate listing or posting module 220 so that when a buyer decides to buy a particular lot a seller can be notified. The buyer fee determination module 300 determines a fee associated to the potential sale of the registered lot based on the number of real estate lots sold and the number of real estate lots purchased by a system user over a selected time period. The system 200 can also include a membership level module 400 communicatively coupled to the fee determination module 300. The buyer fee associated with the potential sale of the real estate lot also depends on a membership level. The system 200 also includes an interface module 600 for displaying a first set of information when a user is viewing the real estate lot and for displaying a second set of information when a potential homeowner is viewing the real estate lot. In some embodiments, the system further includes a rules module 700 for suspending users under selected conditions.

### METHODS OF THE INVENTION

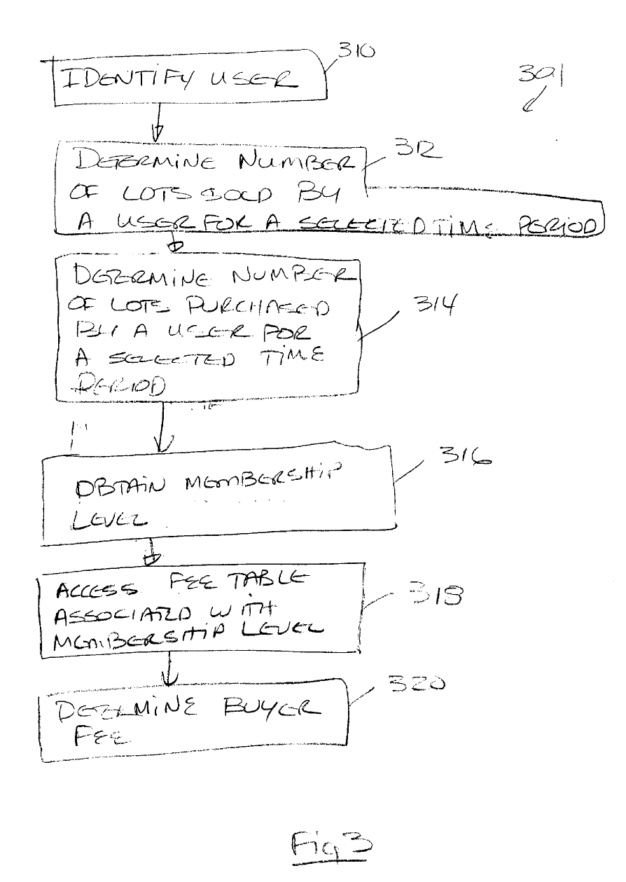

This section describes methods performed by example embodiments of the invention. In certain embodiments, the methods are performed by machine-readable media (e.g., software), while in other embodiments, the methods are performed by hardware or other logic (e.g., digital logic). In this section, FIGS. 3-10 will be discussed.

The registration module 210 prompts a user or person listing a lot or piece of real estate for sale for information related to the lot or piece of real estate. The information includes the city, state, county and township where the lot is located. The specific name of the development is also obtained. A legal description of the lot or block is obtained. Additional information that is obtained includes the school district in which the lot is located, the zip code area in which the lot is located and the type of lot. For example, a type of lot can be a walkout, daylight lot, shaded lot, flat lot or the like. The price of the lot is also obtained. The person registering the lot also has a data field that allows for special features unique to the lot to be listed. Also obtained are the lot dimensions, the development plan, the square foot or acreage of the lot, the building pad size and any architectural requirements. A photo of the lot may, optionally, also be provided. Other information that may be included for the lot includes association information (if applicable), and covenant information (if applicable). The architectural requirements, the covenants and the association information or any other information may also be included as a link to another document or another website. Also included is a GPS coordinates and a street address as well as a link to mapping software that uses the GPS coordinates or the street address to generate driving instructions to the listed or posted lot. Once the registration information is obtained, the information is placed into a listing module 220. The listing module allows the data to be searched. The listing module also provides information to the rules module 700.

FIG. 3 is a flow diagram illustrating a method 301 for generating a buyer fee, according to an example embodiment. The method 301 is carried out in the buyer fee module 300 (shown in FIG. 2). The user is first identified as depicted by reference numeral 310. The database 125 (shown in FIG. 1) is then queried for the data to determine the number of lots sold by a user over a selected amount of time 312, as well as the number of lots purchased by the user over the same selected amount of time, as depicted by reference numeral 314. Membership level is obtained, as depicted by reference numeral 316. A fee table associated with the membership level is then accessed, as depicted by reference numeral 318. The table has the number of lots sold on the Y axis and the number of lots purchased on the X axis. A percentage rate of the transaction or total purchase price for the lot is set forth for the various number of lots sold and lots purchased. The higher, more expensive membership levels generally have a lower the percentage for a particular combination of lots sold versus lots bought than a lower, less expensive membership level. Generally, if more lots are sold than are purchased the percentage drops. Also, when the number of lots bought is greater than the number of lots sold, the percentage of the transaction for the buyer's fee rises. A table of percentages is stored in memory and used to determine the buyer fee as depicted by reference numeral 320. The number of lots purchased and the number of lots sold over a particular period of time allows for a dynamic or changing buyer's fee for the purchase of a lot in the lot exchange system 200 (shown in FIG. 2).

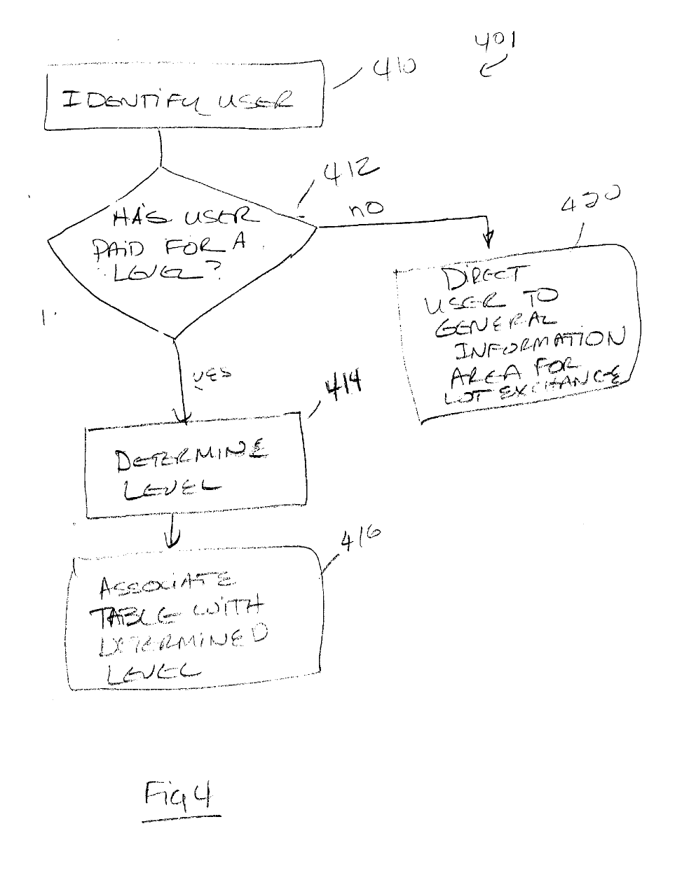

FIG. 4 is a flow diagram illustrating a method 401 for obtaining membership information, according to an example embodiment. The method 401 is carried out in the membership module 400 (shown in FIG. 2). The method 401 first identifies the user, as depicted by reference numeral 410. The decision is then made as to whether the user has paid for a level of use in the lot exchange system, as depicted by reference numeral 412. If the user has paid for a level, the level of use is determined, as depicted by reference numeral 414 and a table is associated with the determined level, as depicted by reference numeral 416. If the user has not paid for a level, the user is identified as a member of the public and directed to general information regarding the lot exchange system 200, as depicted by reference numeral 420. The general information is viewed over the public interface 104 (shown in FIG. 1). The general information includes information about the lot exchange system 200 and includes promotional information, an introduction to the membership levels, and an invitation to join at one of a plurality of levels. The general information also identifies members of the lot exchange system 200 and suggests contacting a member if they are interested in a particular property.

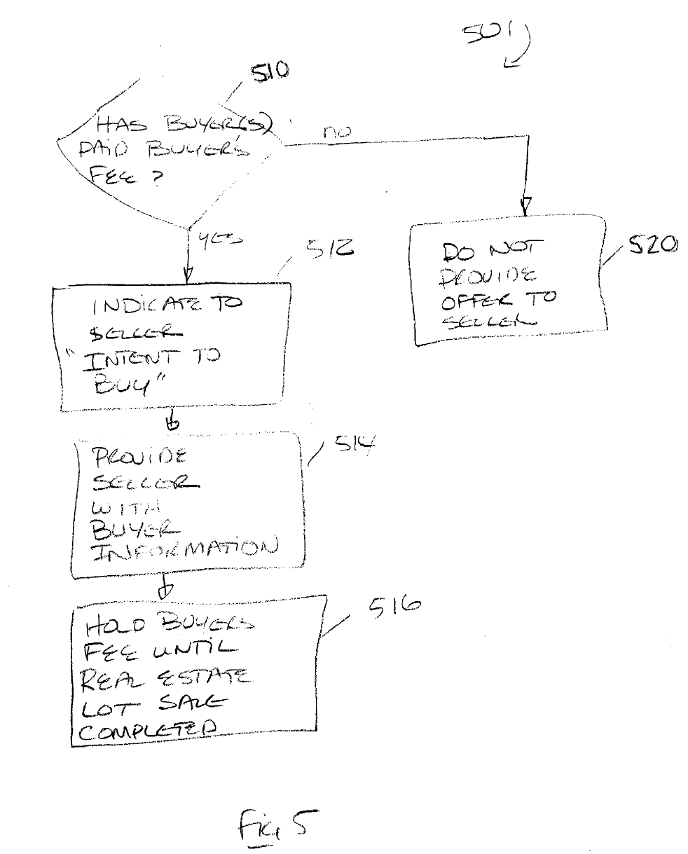

FIG. 5 is a flow diagram illustrating a method 501 for generating an intent to buy indication to a seller of a lot in the lot exchange, according to an example embodiment. The method 501 is implemented by the offer module 500 (shown in FIG. 2). The buyer's fee is generally determined and presented to the potential buyer. The buyer reviews the lot price and the buyer's fee and determines if they would like to make an offer to buy the lot. The lot exchange system 200 presents an intent to buy indication to a seller under certain conditions. Initially it is determined whether or not a buyer or potential buyer has paid the buyer's fee, as depicted by reference numeral 510. The buyer's fee is generally paid to the administrator 101 (see FIG. 1) of the lot exchange system 200. Various forms of payment can be used to make the payment to the administrator 101. If the buyer's fee has been paid, an indication is provided to the seller of an intent to buy as depicted by reference numeral 512. The seller is provided with buyer information, as depicted by reference numeral 514. The buyer's fee is held until the real estate lot sale is completed, as depicted by reference numeral 516. If the buyer has not paid the buyer's fee, then a intent to buy offer or indication is not provided to the seller, as depicted by reference numeral 520.

It should be noted that the lot exchange system supports multiple offers or can support multiple offers. Each potential buyer must pay the buyer's fee in order to have an intent to buy indication given to the seller for the particular potential buyer. The various buyer fees are held until the real estate lot sale is completed. The buyer's fee for the winning bidder or the winning buyer of the lot is taken while the unsuccessful buyers or potential buyers have their buyer's fee returned. In one embodiment, the various buyer's fees are held in escrow until one of the buyers completes the purchase of a parcel of real estate. Other arrangements are also possible as agreed to by the users of the lot exchange system 200.

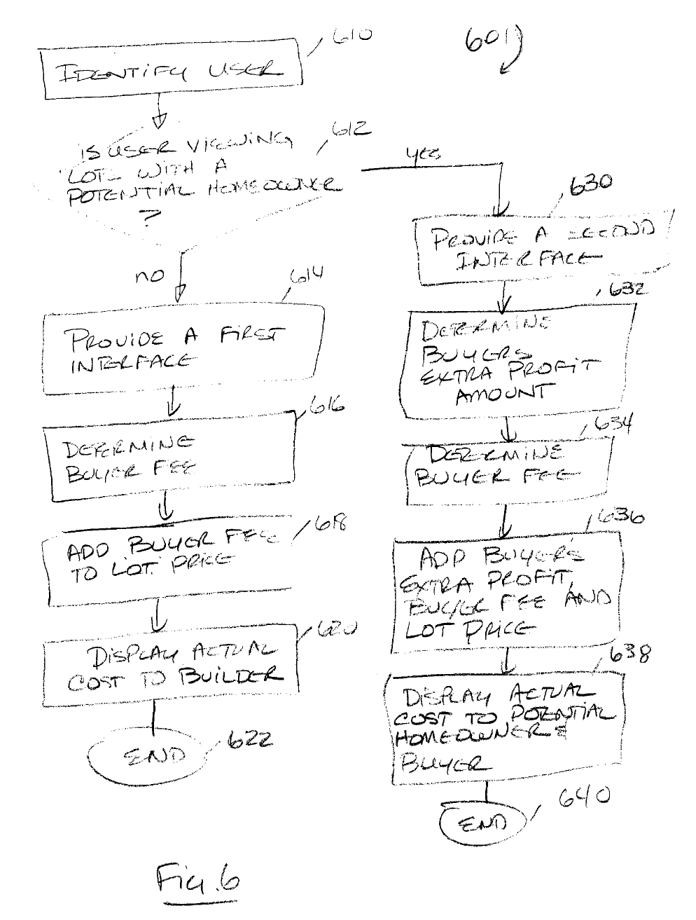

FIG. 6 is a flow diagram illustrating a method 601 for providing multiple interfaces, according to an example embodiment. The method 601 is one example embodiment of a method for operating an interface module 600 to produce a first interface 601, a second interface 602 and a non-user or public interface 603. The interface module 600 can also be thought of as the filter 135, which provides various interfaces to the administrator 101, the developer 102, the builder 103, and to the general public 104 (see FIG. 1). Initially, the user is identified as depicted by reference numeral 610. The decision is then made as to whether the user is viewing lots with a potential home owner, as depicted by reference numeral 612. If the user is not viewing the lots with a potential home owner, a first interface is provided, as depicted by reference numeral 614. The buyer fee for a particular lot is determined 616, and the buyer fee is added to the lot price 618, and the actual cost to the builder is then displayed, as depicted by reference numeral 620, and the process is ended, as depicted by reference numeral 622.

If the user is viewing lots with a potential homeowner, a second interface is provided as depicted by reference numeral 630. The buyer's extra profit margin is determined, as depicted by reference numeral 632, the buyer's fee is determined, as depicted by reference numeral 634, and the buyer's extra profit and the buyer fee and the lot price are summed, as depicted by reference numeral 636, and this actual cost to the potential homeowner is then shown at the second interface, as depicted by reference numeral 638, and the process ends for that particular lot, as depicted by reference numeral 640. The method 601 is generally for controlling interfaces that the builder/buyer would use. The general public interface to the system 104 (see FIG. 1) generally will not include prices but will prompt the general public to contact one of the builders that is a member of the lot exchange for specific pricing information. The developer will have access to selected information on the lot exchange system 200 and the administrator 101 (see FIG. 1) will be able to have total access to the system to fix bugs, change passwords and support the lot exchange system 200.

It should be noted that in one embodiment of the lot exchange system 200, there is no fee associated with listing a real estate, such as a real estate lot for building, in the lot exchange system 200. The lots can be added and removed without penalty as long as there is no intent to buy indication provided to a particular seller of a lot. There are certain exceptions to this policy, which are generally directed toward buyers and sellers that are trying to circumvent the lot exchange system to avoid the buyer's fee. These exceptions will be discussed below.

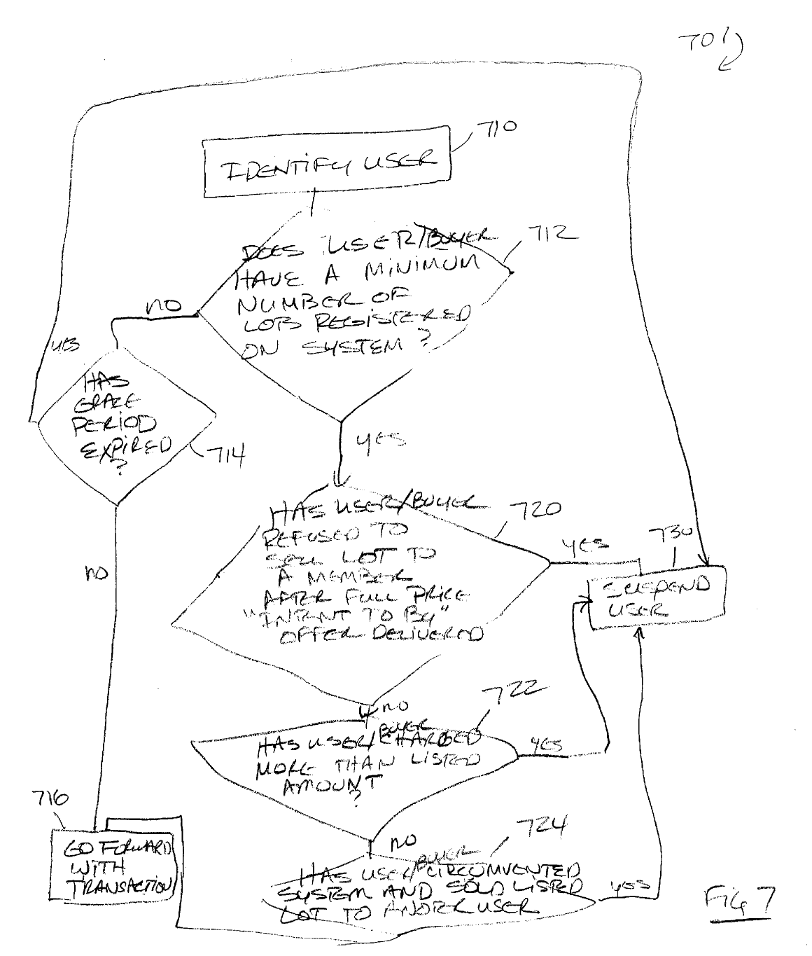

FIG. 7 is a flow diagram illustrating a method 701 for limiting participation of a member, specifically a potential buyer, according to an example embodiment. The method 701 is implemented by the rules module 700 (shown in FIG. 2). The initial step is to identify the user 710. A decision is made as to whether the user buyer has a minimum number of lots registered on the lot exchange system, as depicted by reference numeral 712. A buyer is generally provided with a grace period in which to list additional lots to get up to a minimum number. Therefore, when the buyer has less than the minimum number of lots there is a decision made as to whether the grace period has expired, as depicted by reference numeral 714. If the grace period has not expired, then the system allows the buyer to go forward with the transaction, as depicted by reference numeral 716. If the grace period has expired, then the use by the user is suspended, as depicted by reference numeral 730. If the user buyer does have the minimum number of lots registered on the system, then a decision is made as to whether the user buyer has refused to sell a lot to a member after a full price intent to buy offer was delivered to the buyer when he was selling a lot, as depicted by reference numeral 720. If the buyer has refused to sell a lot under these conditions, then the user is suspended, as depicted by reference numeral 730. If the user has not refused to sell a lot to a member after a full price intent to buy offer is delivered, then a decision is made as to whether the user has ever charged more than the listed amount of the lot price to another user of the system, as depicted by reference numeral 722. If the user has charged more than the listed amount at any time the user is suspended, as depicted by reference numeral 730. If he is not charged more than the listed amount for a lot, a decision is made as to whether the buyer has circumvented the system and sold a previously listed lot to another user, as depicted by reference numeral 724. If he has taken a lot previously listed and sold it to another user of the system, then the user is suspended, as depicted by reference numeral 730. If he has not circumvented the system, the transaction moves forward, as depicted by reference numeral 716.

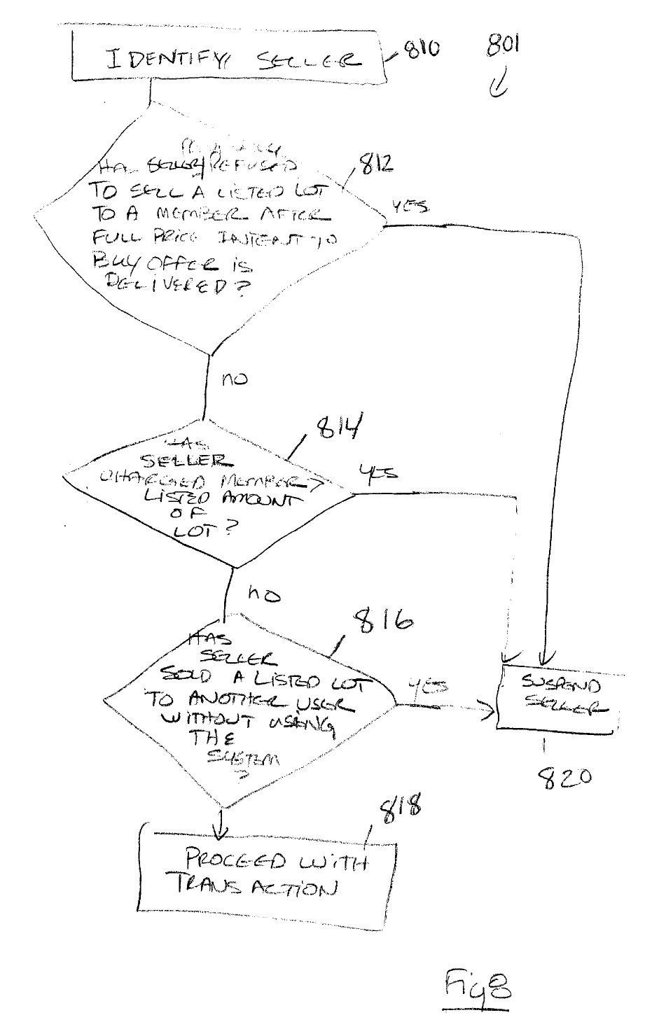

FIG. 8 is a flow diagram of another method 801 for limiting participation of a member and specifically a seller, according to an example embodiment. The method 801 is one of the methods for an example embodiment of a method implemented by the rules module 700 of the lot exchange system 200 (see FIG. 2). Initially, the seller is identified as depicted by reference numeral 810. A decision is then made as to whether the seller previously refused to sell a listed lot to a member after the full price intent to buy offer was delivered, as depicted by reference numeral 812. If so, the seller is suspended. If not, a decision is made as to whether the seller has charged a member more than the listed amount for a lot, as depicted by reference numeral 814. If the answer to this decision is yes, than the seller is suspended, as depicted by reference numeral 820. If not, then a decision is made as to whether the seller has sold a listed lot to another user without using this system, as depicted by reference numeral 816. If the seller has sold a listed lot without using the system to another user, then the seller is suspended, as depicted by reference numeral 820. If not, then you precede or go forward with the transaction, as depicted by reference numeral 818. The methods 801 and 701 look at both the buyer and the seller in a particular transaction and look at past transactions to determine if, in their roles as either a buyer or a seller, certain rules have been violated. It should be noted that many of the rules between the method 801 and the method 701 appear to be the same and are directed toward the sales of lots using the lot exchange system. It should also be noted that the rules set forth in 701 and 801 are not all inclusive and that other rules could be implemented in various embodiments of the lot exchange system 200 (see FIG. 2).

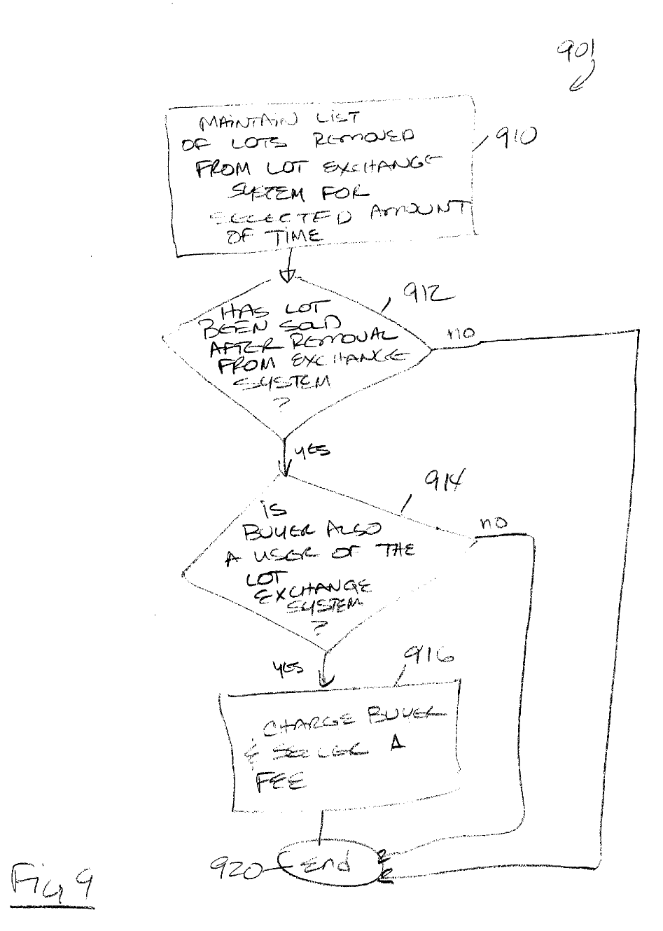

FIG. 9 is a flow diagram illustrating a method 901 for penalizing a buyer and seller that circumvent the lot exchange system, according to an example embodiment. This method 901 is also implemented by the rules module 700. Initially, a list of lots that have been removed from the lot exchange system is maintained for a selected amount of time, as depicted by reference numeral 910. A decision is made as to whether a lot on the maintain list has been sold after removal from the exchange system as depicted by reference numeral 912. If not, no penalty is assessed and the method ends, as depicted by reference numeral 920. If so, a decision is made as to whether the buyer is also a user of the lot exchange system, as depicted by reference numeral 914. If the buyer of the previously listed lot is not a user of the lot exchange system, the method 901 ends. If the buyer is a user of the lot exchange system, then both the buyer and the seller are charged the user fee, as depicted by reference numeral 916. Various implementations can be used in various embodiments. In one example embodiment, the user fee is determined for the transaction price of the lot and the buyer and the seller split the fee. As depicted above, most of the time the seller of a lot is not charged a fee for listing the lot or selling the lot. Fees are generally paid by the buyers, except in this situation where it appears the buyer and seller use the lot exchange system to find one another and then the seller decided to remove the lot from the lot exchange and sell to the seller outside of the lot exchange system 200. This penalty method accesses a fee to the seller, thereby incenting the seller to stick with the lot exchange system where no fee will be accessed to the seller of the lot. It should be noted that this is not the only type of penalty rule that can be implemented by the rules module. Other penalties may be implemented in order to incent users of the lot exchange system to use the system as intended.

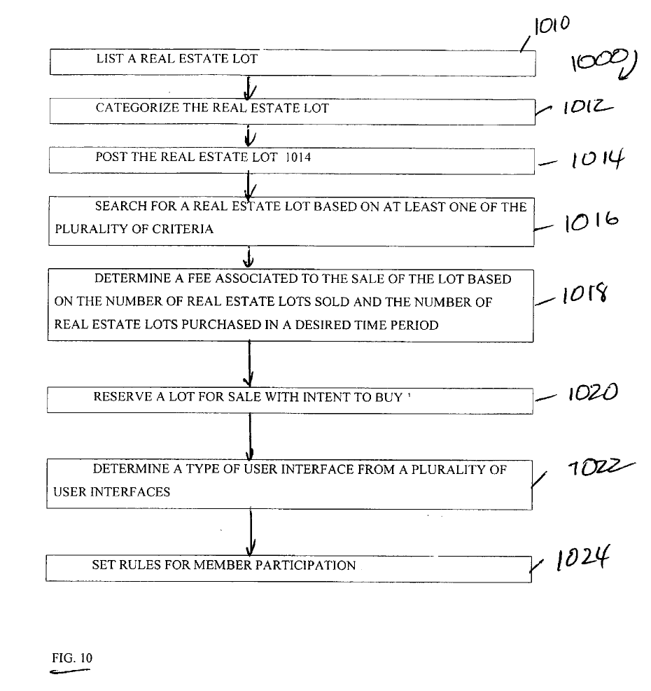

FIG. 10 is a flow diagram of a method 1000 of selling and buying a real estate lot, according to an example embodiment. The method of selling and buying a real estate lot 1000 includes registering a real estate lot 1010, posting the registered real estate lot 1012, determining a fee associated to the potential sale of the registered lot 1018, and reserving a registered real estate lot for purchase 1020. The fee is based on the number of real estate lots sold and the number of real estate lots purchased by a user in a selected time period. The method 1000 also includes determining a fee associated with the sale of a real estate lot based on at least one additional factor. In one example embodiment, the fee associated with the sale of a real estate lot is also based on a membership level. A first user pays a greater amount for a first level membership than a second user pays for a second level membership. The fee paid by the first user is less than the fee paid by the second user when the first user and the second user have the same number of lots sold and number of lots purchased for a selected amount of time. Registering a real estate lot 1010 includes categorizing a lot based on a plurality of criteria. In some embodiments, the plurality of criteria are searchable. In some embodiments, the method 1000 includes searching for a real estate lot based on at least one of the plurality of criteria 1016. The method 1000 also includes determining a type of user interface from a plurality of user interfaces 1022. A first price for a real estate lot is displayed in response to a determination of a first interface, and a second price for the same real estate lot is displayed in response to a determination of a second interface. In some embodiments, the first price is different than the second price, by a profit amount for a buyer of the real estate lot. In some embodiments, the method also includes requiring a membership fee to buy or sell a real estate lot, and setting rules for member participation 1024. Reserving a lot for purchase 1020 includes paying a selected amount to an administrator, and indicating an intent to buy in response to receiving the selected amount. The buyer, in some embodiments, pays the fee associated with the sale of the registered lot.

### Hardware and Operating Environment

This section provides an overview of the example hardware and the operating environment in which embodiments of the invention can be practiced.

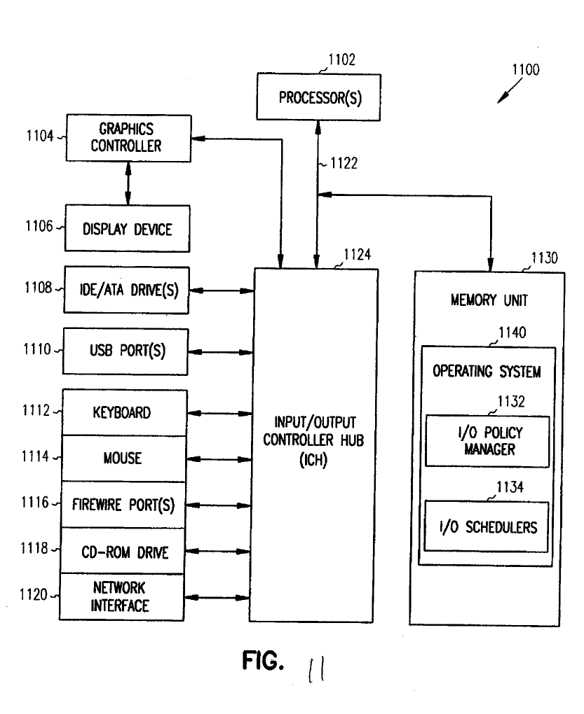

FIG. 11 illustrates an example computer system used in conjunction with certain embodiments of the invention. As illustrated in FIG. 10, computer system 1100 comprises processor(s) 1102. The computer system 1100 also includes a memory unit 1130, processor bus 1122, and Input/Output controller hub (ICH) 1124. The processor(s) 1102, memory unit 1130, and ICH 1124 are coupled to the processor bus 1122. The processor(s) 1102 may comprise any suitable processor architecture. The computer system 1100 may comprise one, two, three, or more processors, any of which may execute a set of instructions in accordance with embodiments of the present invention.

The memory unit 1130 includes an operating system 1140, which includes an I/O scheduling policy manager 1132 and I/O schedulers 1134. The memory unit 1130 stores data and/or instructions, and may comprise any suitable memory, such as a dynamic random access memory (DRAM), for example. The computer system 1100 also includes IDE drive(s) 1108 and/or other suitable storage devices. A graphics controller 1104 controls the display of information on a display device 1106, according to embodiments of the invention.

The Input/Output controller hub (ICH) 1124 provides an interface to I/O devices or peripheral components for the computer system 1100. The ICH 1124 may comprise any suitable interface controller to provide for any suitable communication link to the processor(s) 1102, memory unit 1130 and/or to any suitable device or component in communication with the ICH 1124. For one embodiment of the invention, the ICH 1124 provides suitable arbitration and buffering for each interface.

For one embodiment of the invention, the ICH 1124 provides an interface to one or more suitable integrated drive electronics (IDE) drives 1108, such as a hard disk drive (HDD) or compact disc read only memory (CD ROM) drive, or to suitable universal serial bus (USB) devices through one or more USB ports 1110. For one embodiment, the ICH 1124 also provides an interface to a keyboard 1112, a mouse 1114, a CD-ROM drive 1118, and one or more suitable devices through one or more firewire ports 1116. The ICH 1124 also provides a network interface 1120 though which the computer system 1100 can communicate with other computers and/or devices.

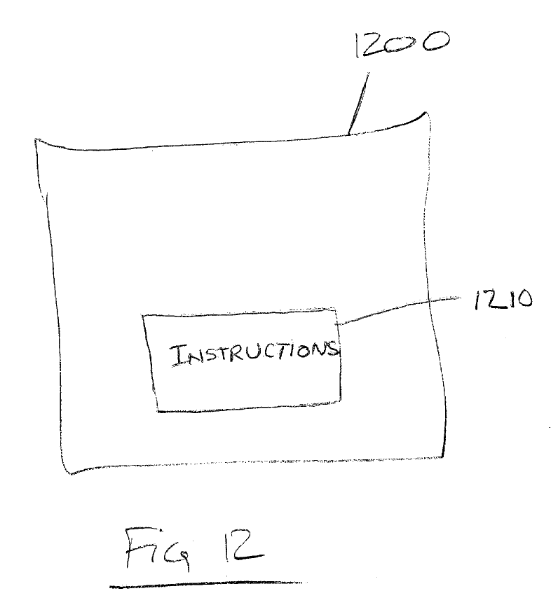

FIG. 12 is a schematic diagram of a machine-readable medium 1200, according to an example embodiment. The machine-readable medium 1200 includes instructions 1210 that, when executed by a machine, cause the machine to perform operations including reserving a registered real estate lot for purchase, and determining a fee associated to the sale of the registered lot based on the number of real estate lots sold and the number of real estate lots purchased by a user in a selected time period. The machine-readable medium can further cause the machine to perform operations that include determining a fee associated with the sale of a real estate lot based on at least one additional factor. In some embodiments, the fee associated with the sale of a real estate lot is also based on a membership level. The machine-readable medium can further cause the machine to perform operations that include determining a type of user interface from a plurality of user interfaces. A first price for a real estate lot is displayed in response to a determination of a first interface, and a second price for the same real estate lot is displayed in response to a determination of a second interface.

In one embodiment, the computer system 1100 includes a machine-readable medium 1200 that stores a set of instructions 1210 (e.g., software) embodying any one, or all, of the methodologies for dynamically loading object modules described herein. Furthermore, software can reside, completely or at least partially, within memory unit 1130 and/or within the processor(s) 1102.

Thus, a system, method, and machine-readable medium including instructions for Input/Output scheduling have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

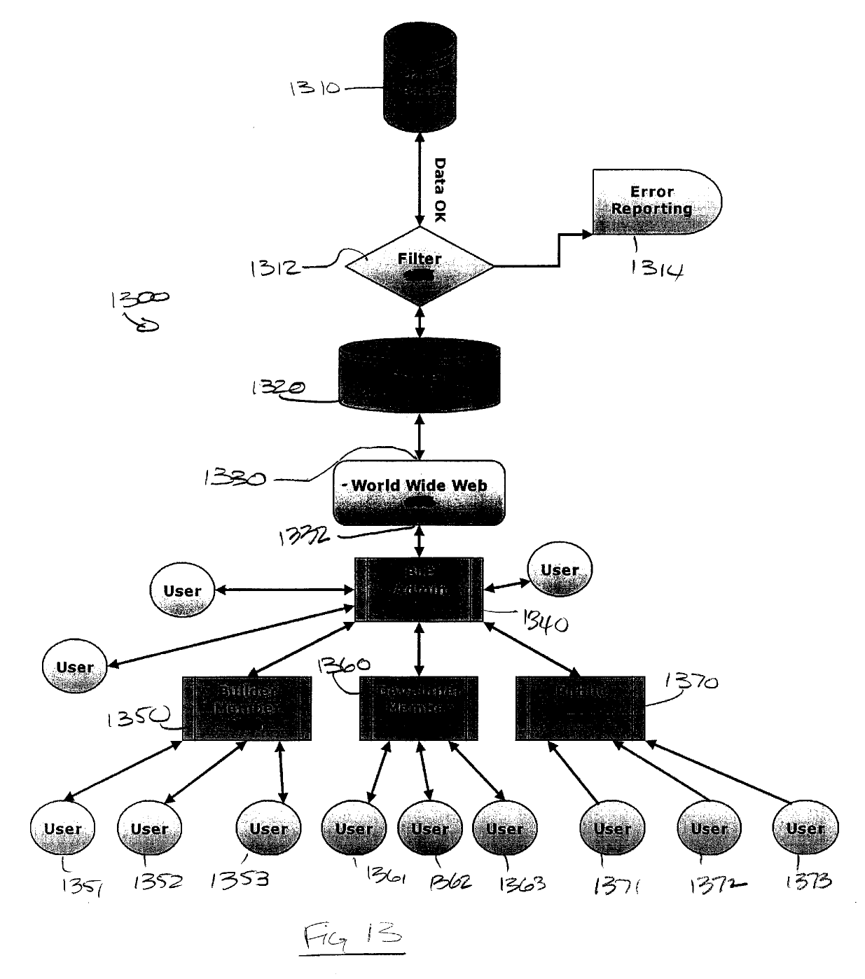

FIG. 13 is a diagrammatic representation of a system architecture 1300, according to another example embodiment of the invention. The system, or system architecture 1300, includes a database 1310, a filter for the database 1312, and a server 1320. The database 1310 and server 1320 hold information which is available through a portal over the world-wide web 1330. The information in the database 1310 is filtered by the filter 1312 to scrub the data or to validate or verify the data. If the data is not verified, an error reporting module 1314 is enabled and sets forth an error reporting procedure that indicated there is an error in the information in the database 1310. The data is then placed in a server 1320 which can be viewed through a portal available to the world-wide web 1330. Various modules associated with a builder's land exchange system are also attached to another portal 1332 of the world-wide web. The various modules include a builder's lot exchange administrative module 1340, a builder member module 1350, a developer member module, 1360 and a module for the public 1370. The builder member module 1350, the developer member module 1360, and the public module 1370 act through the builder's lot exchange administrative module 1340 to access the world-wide web through the portal 1332. Various users or administrators are able to use the builder's lot exchange administrative module 1340. The builder member module 1350 includes builder member users such as 1351, 1352, and 1353. The developer member module 1360 allows various developer member users, such as users 1361, 1362, and 1363. The public module 1370 has any member of the public as a user including the users 1371, 1372, and 1373.

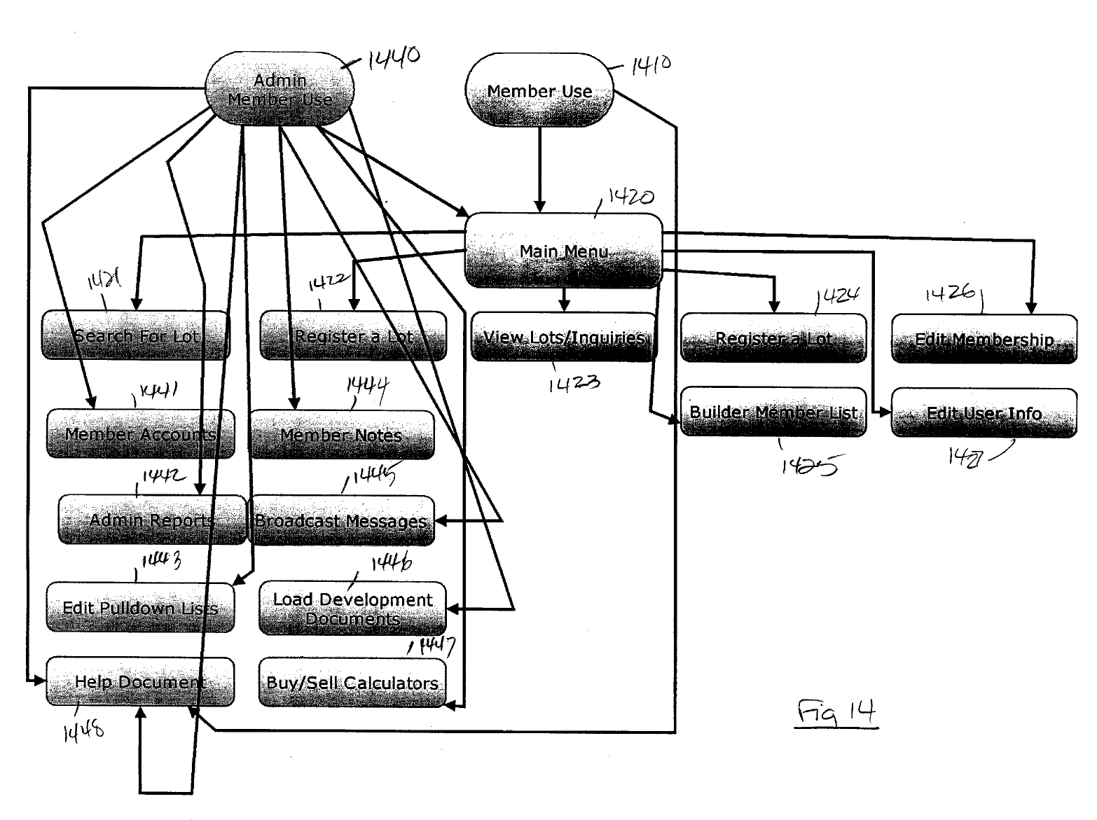

FIG. 14 is a diagram illustrating a number of functions that both administrative members can use, as well as other members can use, according to an example embodiment. In other words, FIG. 14 shows the various functions that an administrator can use through the builders lot exchange administrative module 1340 (see FIG. 13), and also shows what the other users are able to do. The other members include builder member users, developer member users, as well as public member users. The administrative use designated by the number 1440 includes access to member accounts 1441, administrative reports 1442, the ability to edit pull-down lists 1443, the ability to make notes regarding the various other members 1444, the ability to broadcast messages 1445, the ability to load development documents 1446, and the ability to calculate buy and sell transaction fees 1447. The administrator is also able to access help documents 1448, as well as to edit the help documents for other users to view. The other member use is designated by the reference numeral 1410. The other members that are able to use include builder member users 1351, 1352, 1353, and developer member users 1361, 1362, 1363, and public member users 1371, 1372, and 1373 (see FIG. 3). The other member use or users 1410 include the ability access the main menu of a program 1420. From the main menu the other users are able to search for lots 1421, register a lot 1422, view lots and inquiries regarding those lots 1423, register a lot 1424, view a builder member list 1425, edit membership information for their particular membership 1426, and then edit the user information as depicted by reference numeral 1427. Member use also includes access to help documents 1448.

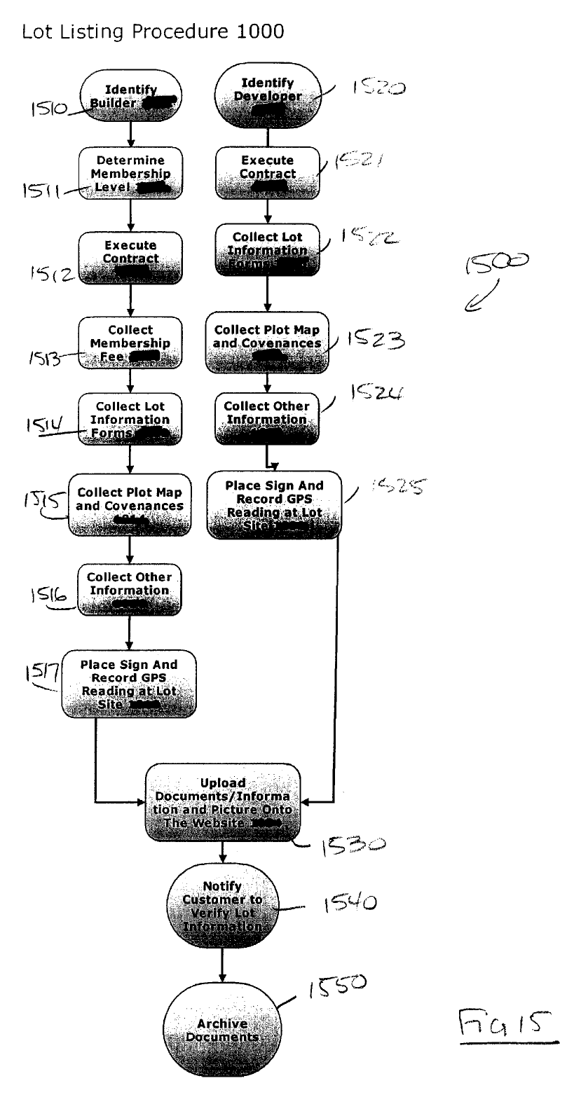

FIG. 15 is a flow diagram illustrating a method 1500 for listing lots, according to an example embodiment. The method 1500 include identifying a user either as a builder, as depicted by reference numeral 1510, or identifying a user as a developer, as depicted by reference numeral 1520. If the user is a builder 1510, a membership level is determined 1511, and an appropriate contract is executed 1510, and a membership fee is collected 1513. Lot information for a lot that the builder owns is then collected 1514, as well as collecting a plot map and various conveyances associated with the lot 1550. Other information is also collected about the lot 1516, and a sign is placed on the lot, a GPS reading is recorded at the lot, as depicted by reference numeral 1517. Once all the information is collected, the documents and information and a picture of the lot is uploaded to the website, as depicted by reference numeral 1530. If the user is identified as a developer 1520, a contract is executed 1521 and lot information forms are collected 1522, as well as a plot map and conveyance information associated with a lot or lots, as depicted by reference numeral 1523. Other information regarding the lot or lots are also collected, as depicted by reference numeral 1524. A sign is placed on the lot and a GPS reading is taken at the lot and recorded, as depicted by reference numeral 1525. This information is then also uploaded along with a picture of the lot onto the website, as depicted by reference numeral 1530. Once the information has been upload, the customer is notified and asked to verify the information associated with the lot, as depicted by reference numeral 1540, and once verified, the documents related to the lot and the information related to the lot is then archived, as depicted by reference numeral 1550.

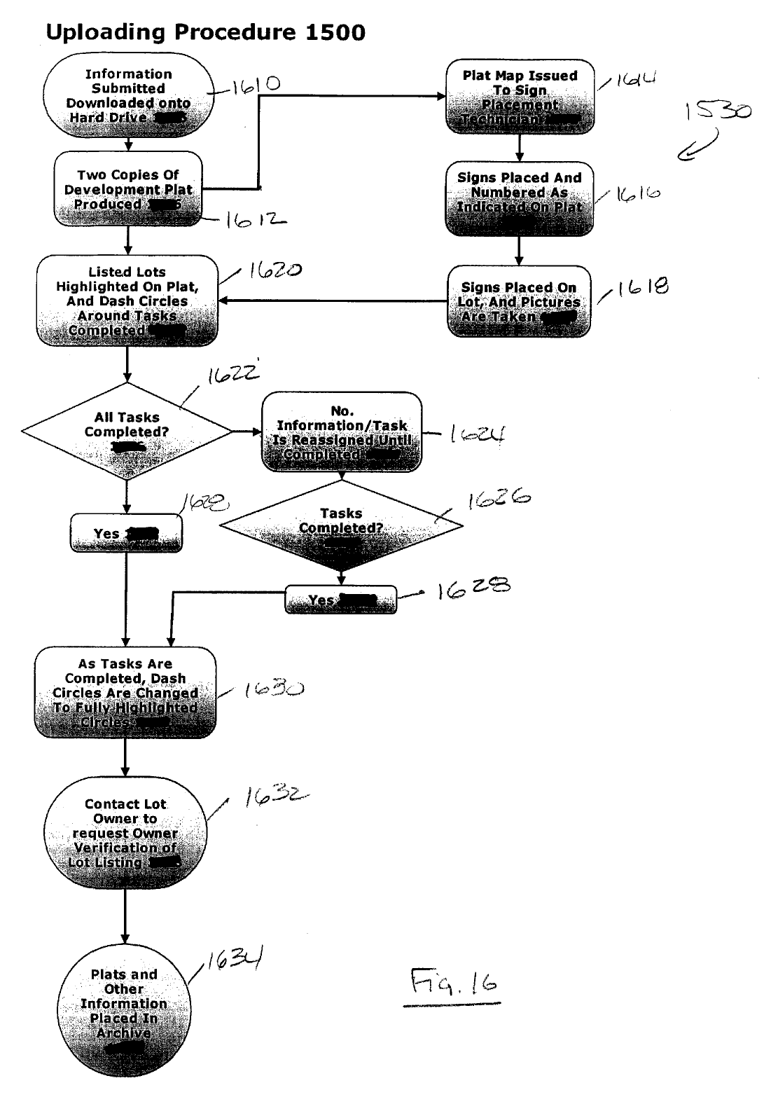

FIG. 16 is flow diagram of a method 1530 for uploading documents related to various lots, according to an example embodiment. Initially, the minute information is downloaded onto a hard disk drive or other storage device, as depicted by reference numeral 1610. Two copies of the development plat are produced 1612. A plat map is issued to assigned placement technician 1640 and signs are placed and numbered as indicated on the plat 1616, and signs are placed on the lot and pictures are taken 1618. In addition, the listed lots are highlighted on the plat and dash circles are placed around the tasks that are completed 1620. Next comes a decision tree to determine if all the tasks are completed 1622. If the tasks are not completed, as depicted by reference numeral 1624, the task is reassigned until completed and a decision is made as to whether or not the tasks are completed once again, as depicted by reference numeral 1626. Once the tasks are completed, as depicted by reference numeral 1628, the dash circles are changed to fully highlighted circles thereby indicating that the various tasks are completed, as depicted by reference numeral 1630. The lot owner is then contacted to request verification of the lot listing, as depicted by reference numeral 632. Once the lot owner verifies the requested information, plats and other information are archived 1634.

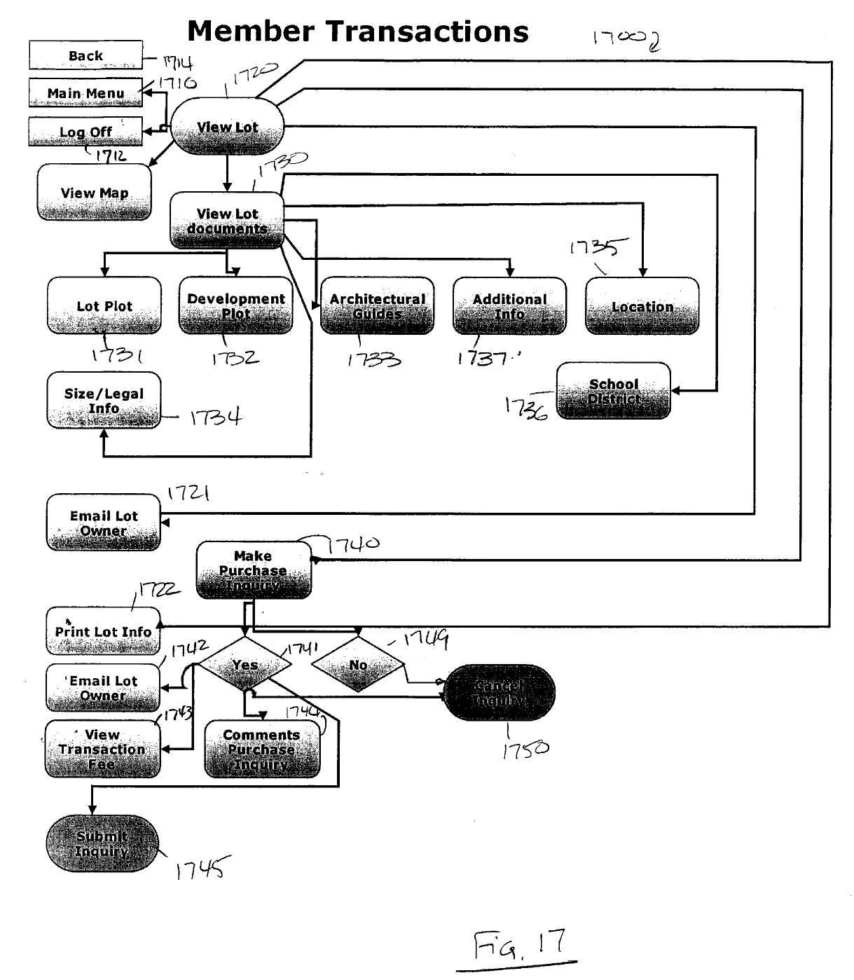

FIG. 17 is a flow diagram illustrating various member transactions 1700, according to an example embodiment. The various member transactions 1700 include viewing a main menu 1710, logging off 1712 and having a backward and forward button 1714. From the main menu the lot can be viewed 1720. While viewing the lot 1720, several member transactions can take place including emailing the lot owners 1721, making a purchase inquiry 1740, printing out lot information 1722, and viewing various lot documents 1730. Viewing lot documents includes viewing the plot of the lot 1731, the plot of the development 1732, any architectural guidelines 1733, and the legal description as well as the size information, as depicted by 1734. Additional lot documents include maps or locational data 1735, as well as information on the school district 1736. Additional information 1737 can also be included amongst the lot documents which can be viewed. The additional information is any information that may be associated with a particular lot that is listed or being viewed. A member can also make a purchasing inquiry 1740. The member first determines if they would like to make a purchase inquiry. If they would like to make a purchase inquiry, as depicted by decision box 1741, they can choose to email the lot owner with specific questions about the inquiry 1742. They can also view a transaction fee 1743, as well as comment on the purchase inquiry 1744. Still another option is to submit an inquiry officially, as depicted by 1745. If after viewing some of the information regarding the lot and specifically the information related to the purchasing inquiry, the inquirer can determine that he is uninterested and cancel the inquiry, as depicted by reference numeral 1750. In addition, a lot owner or potential buyer may inadvertently be placed into an area regarding a purchase inquiry or may quickly decide that they would not want to make a purchase inquiry and therefore they decided against it, as depicted by reference numeral 1749, and the inquiry is cancelled 1750.

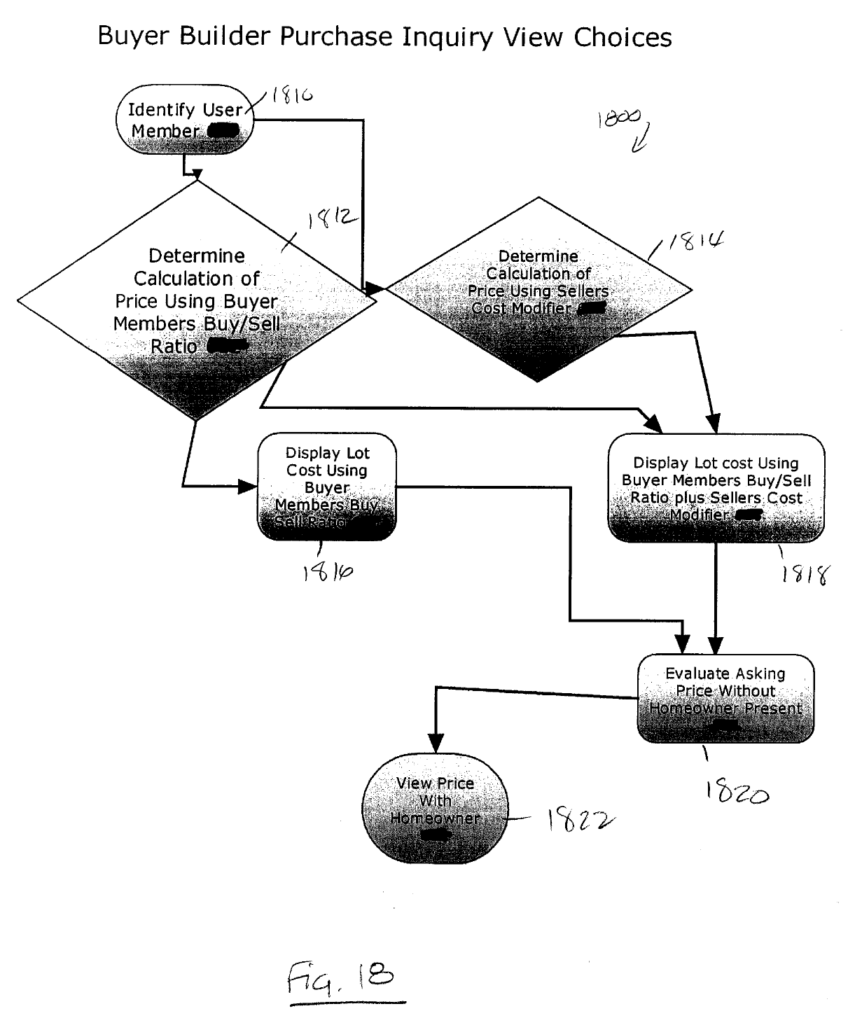

FIG. 18 is a flow diagram of a method 1800 related to buyer/builder purchase inquiries, according to an example embodiment. The method includes identifying the user member 1810 as a buyer/builder. A determination or a calculation is made of the price using a member's buy/sell ratio 1812. As discussed previously, the number of lots bought and sold, or the number of lots listed can be used to set up certain ratios for providing transactional costs or to determine transaction costs associated with buying a lot. The seller can also put in a cost modifier. The method 1800 can also include calculation of the price using the seller's cost modifier 1814. Lot costs can then be displayed using the buyer member's buy/sell ratio 1816 or the lot costs can be displayed using the member's buy/sell ratio plus the seller's cost modifier as depicted by 1818. In one instance, the asking price can be viewed without the homeowner present, as depicted by 1820, and the price can also be viewed with the homeowner present 1822. Typically, the price without the homeowner present excludes the seller's cost modifier. In other words, without the seller's cost modifier, the seller of the lot will see what the actual cost to the seller is. Adding the seller's modifier is generally used when viewing the price with the homeowner, as depicted by reference numeral 1822. The seller's cost modifier allows the seller of the lot to produce or make a profit on the lot that is being purchased.

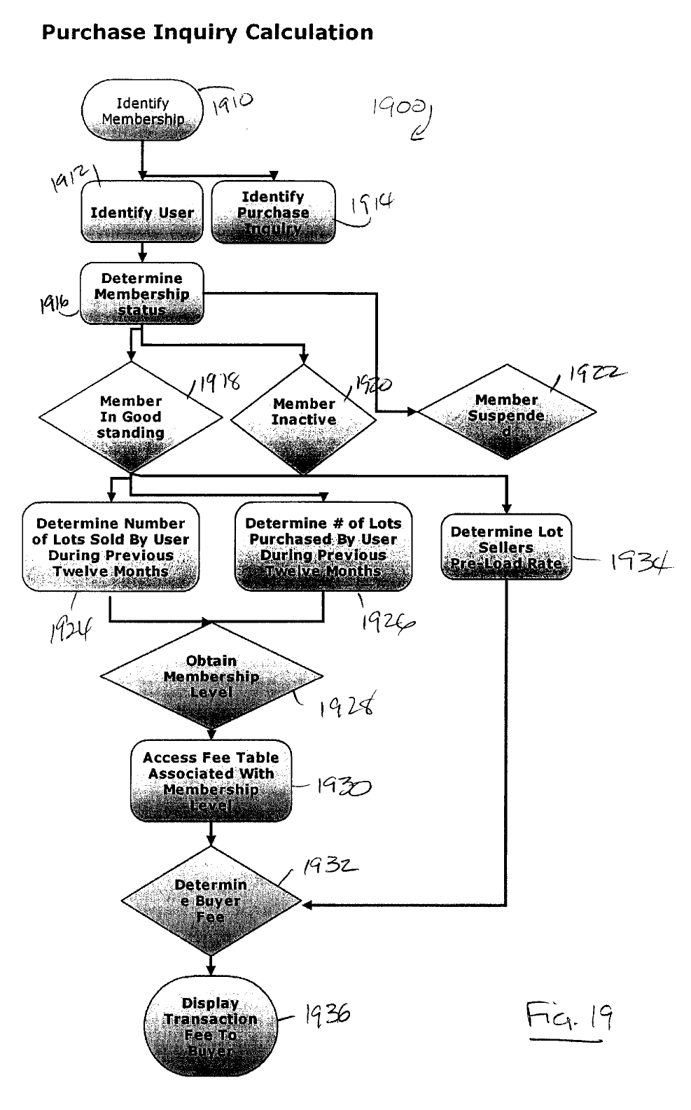

FIG. 19 is flow diagram of a method 1900 for determining transaction fees as a result of a purchase inquiry, according to an example embodiment. The member or particular member is the first identified, as depicted by reference numeral 1910. The user or specific user is then identified 1912, and then a purchase inquiry is also identified 1914. After identifying the user, the user's membership status is then determined, as depicted by 1916. It is determined whether the particular user is a member in good standing 1918, an inactive member 1920, or a suspended member 1922. If the member is a member in good standing 1919, the number of lots sold by the user during the previous 12 months is determined 1924, and the number of lots purchased by the user during the previous 12 months is also determined 1926. A membership level 1928 is also obtained. Once the membership level is obtained 1928, a fee table associated with the membership level is accessed 1930 and a buyer's fee is determined 1932. Also for a member in good standing, the lot seller's preload rate is determined 1934. Using the determined buyer's fee 1932 and the lot seller's preload rate 1934, a transaction fee is then displayed to the buyer, as depicted by reference numeral 1936.

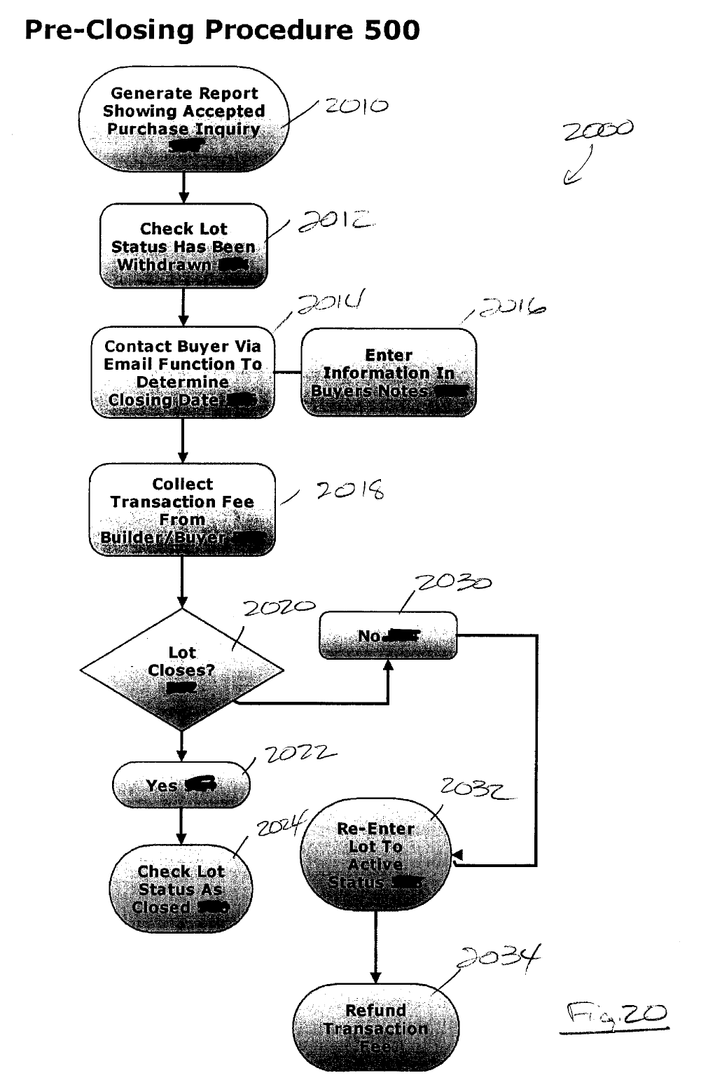

FIG. 20 is a flow diagram of a preclosing method 2000 for buying and selling real estate, such as real estate lots, according to an example embodiment. Preclosing method 2000 includes generating a report showing an accepted purchase inquiry 2010, and then checking the lot status to make sure that it has been withdrawn 2012. Using an email function, the buyer is contacted and a closing date is determined as depicted by reference numeral 2014. Information related to the closing date and other details are then noted in the buyer's notes, as depicted by reference numeral 2016. A transaction fee is then collected from the builder/buyer 2018 and it is then determined whether or not the lot closes, as depicted by reference numeral 2020. If the lot closes, as depicted by reference numeral 2022, the check lot status is listed as closed 2024. If the lot fails to close, in other words if the purchase is not consummated, as depicted by reference numeral 2030, the lot is reentered into an active status 2032 and the transaction fee is refunded, as depicted by 2034.

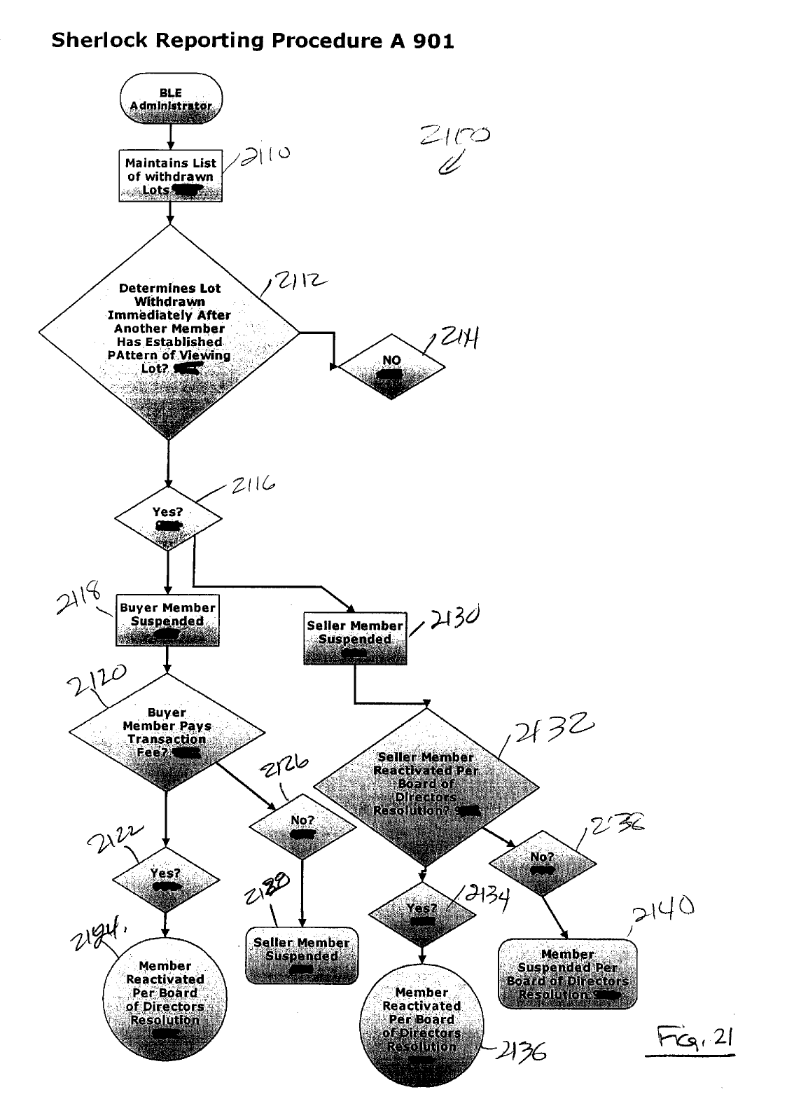

FIG. 21 is a flow diagram of a method 2100 for determining if a buyer and seller are trying to or attempting to circumvent the lot exchange system, according to an example embodiment. The method includes maintaining a list of withdrawn lots, as depicted by reference numeral 2110. The next step in the procedure is to determine whether or not the lot is withdrawn immediately after another member has established a pattern of viewing the lot 2112. If there is no other member that has established a pattern of viewing, the reporting procedure stops, as depicted by 2114. If the lot is withdrawn after another member has established a pattern of viewing, the method 2100 continues as depicted by reference numeral 2116. Depending upon the type of user, a buyer member may be suspended, as depicted by reference numeral 2118. If the buyer member is suspended and yet pays the transaction fee a determination is made as to whether the buyer member pays the transaction fee 2120. If the buyer member does pay the transaction fee, as depicted by 2122 then the member is reactivated per the Board of Director's resolution 2124. If the buyer member refuses or fails to pay the transaction fee, as depicted by reference numeral 2126, then the seller member is suspended, as depicted by reference numeral 2128.

In some instances a seller member may be suspended, as depicted by reference numeral 2130. The seller member, once suspended, may only be reactivated per a Board of Director's resolution 2132. If the Board of Directors agrees to reactivate the seller member, as depicted by 2134, the member is reactivated per Board of Director's resolution, as depicted by 2136. If the Board of Directors decides against reactivating the seller member, as depicted by 2138, the seller member is then suspended per the Board of Director's resolution 2140.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A method of selling and buying a real estate lot comprising:
registering a real estate lot;
posting the registered real estate lot;
reserving a registered real estate lot for purchase; and
determining a fee associated to the sale of the registered lot based on the number of real estate lots sold and the number of real estate lots purchased by a user in a selected time period.

2. The method of claim 1 further comprising determining a fee associated with the sale of a real estate lot based on at least one additional factor.

3. The method of claim 1 further comprising determining a fee associated with the sale of a real estate lot based on a membership level.

4. The method of claim 1 further comprising determining a fee associated with the sale of a real estate lot is based on one of a plurality of membership levels, wherein a first user pays a greater amount for a first level membership than a second user pays for a second level membership, wherein the fee paid by the first user is less than the fee paid by the second user when the first user and the second user have the same number of lots sold and number of lots purchased for a selected amount of time.

5. The method of claim 1 wherein registering a real estate lot includes categorizing a lot based on a plurality of criteria.

6. The method of claim 5 wherein the plurality of criteria are searchable.

7. The method of claim 5 further comprising searching for a real estate lot based on at least one of the plurality of criteria.

8. The method of claim 1 further comprising:
determining a type of user interface from a plurality of user interfaces;
displaying a first price for a real estate lot in response to a determination of a first interface; and
displaying a second price for the same real estate lot in response to a determination of a second interface.

9. The method of claim 8 wherein the first price is different than the second price, wherein the first price differs from the second price by a profit amount for a buyer of the real estate lot.

10. The method of claim 1 further comprising:
requiring a membership fee to buy or sell a real estate lot; and
setting rules for suspending a member.

11. The method of claim 1 wherein reserving a lot includes:
paying a selected amount to an administrator; and
indicating an intent to buy in response to receiving the selected amount.

12. The method of claim 1, wherein the buyer pays the fee associated with the sale of the registered lot.

13. A machine-readable medium that provides instructions that, when executed by a machine, cause the machine to perform operations comprising:
reserving a registered real estate lot for purchase; and
determining a fee associated to the sale of the registered lot based on the number of real estate lots sold and the number of real estate lots purchased by a user in a selected time period.

14. The machine-readable medium that provides instructions of claim 13 that, when executed by a machine, further cause the machine to perform operations comprising determining a fee associated with the sale of a real estate lot based on at least one additional factor.

15. The machine-readable medium that provides instructions of claim 13 that, when executed by a machine, further cause the machine to perform operations comprising determining a fee associated with the sale of a real estate lot based on a membership level.

16. The machine-readable medium that provides instructions of claim 13 that, when executed by a machine, further cause the machine to perform operations comprising:
determining a type of user interface from a plurality of user interfaces;
displaying a first price for a real estate lot in response to a determination of a first interface; and
displaying a second price for the same real estate lot in response to a determination of a second interface.

17. A system for selling and buying a real estate lots comprising:
a real estate lot registration module;
a real estate lot posting module communicatively coupled to the real estate lot registration module;
an intent to buy module communicatively coupled to the real estate posting module; and
a fee determination module for determining a fee associated to the potential sale of the registered lot based on the number of real estate lots sold and the number of real estate lots purchased by a system user over a selected time period.

18. The system of claim 17, wherein the system further comprises a membership level module communicatively coupled to the fee determination module, wherein the fee associated with the potential sale of the real estate lot also depends on a membership level.

19. The system of claim 17, wherein the system further comprises a interface module for displaying a first set of information when a user is viewing the real estate lot and for displaying a second set of information when a potential homeowner is viewing the real estate lot.

20. The system of claim 17 further comprising a rules module for suspending users under selected conditions.
